(19) United States
(12) Patent Application Publication
(10) Pub. No.: US 2003/0222849 A1
(43) Pub. Date: Dec. 4, 2003

(54) Laser-based user input device for electronic projection displays

(76) Inventor: Gary K. Starkweather, Bellevue, WA (US)

Correspondence Address: IPSOLON LLP, 805 SW BROADWAY, #2740, PORTLAND, OR, 97205, US

(21) Appl. No.: 10/161,344

(22) Filed: May 31, 2002

(51) Int. Cl. G09G 5/00

(52) U.S. Cl. 345/156

(57) ABSTRACT

A remote electronic projection display control system and method are associated with an electronic projector for projecting an image onto a display screen. With regard to the system, a narrow-beam visible light pointer, such as a laser pointer, is operable by a user to direct narrow-beam visible light to the display screen. A multi-pixel light sensor or camera is positioned to receive from the display screen the narrow-beam visible light that is directed there. A controller receives from the multi-pixel light sensor a signal corresponding to the narrow-beam visible light directed to the display screen. The controller correlates the narrow-beam visible light with a display screen location and generates a control signal based upon the display screen location. For example, the user may activate a graphical user interface control rendered on the display screen by pressing a light-controlling button that modulates the narrow-beam visible light. The multi-pixel light sensor would detect the modulation and the corresponding activation of the graphical control.

### TECHNICAL FIELD

The present invention relates to interaction schema for computer displays and, in particular, to providing an interaction schema for a projection display through a hand-held, untethered narrow-beam visible light pointer that is operable by a user to direct narrow-beam visible light to the display screen.

### BACKGROUND AND SUMMARY

There is a wide variety of interaction schema by which users can interact with computer displays, and particularly graphical user displays. For a single-operator computer, for example, the interaction schema may include any graphical user input device including a computer mouse, trackball, joystick, touch-pad, touch-screen, light pen, etc. These interaction schema relate well to the relatively close positioning between the user and the computer display.

However, not all electronic- or computer-based display systems are as well adapted to such conventional interaction schema. For example, some electronic- or computer-based display systems project a display image onto a display screen for viewing by typically multiple viewers. Commonly, at least one viewer is making a presentation to one or more observing viewers, but such display systems may be used in other applications as well. These display systems employ an electronic or multimedia projector that may use liquid crystal cells, digital micromirrors, etc. to form a display image that is projected onto a display screen. Such electronic projectors are available under a variety of trademarks including Sony®, Hitachi®, Sharp®, In Focus®, Epson®, etc.

In a common use of an electronic projector, the user, operator, or presenter controlling the projector is commonly separate from the projector and possibly even mobile relative to it. In this context, a conventional graphical user input device like a computer mouse is untenable. Accordingly, electronic projector manufacturers have developed untethered radio frequency or infrared remote controls to direct a range of dedicated control signals to a receiver associated with an electronic projector. These remote control devices allow a user to provide a range of commands to the electronic projector from various remote positions relative to the projector.

In some instances, the user, operator, or presenter controlling the projector will also use a handheld “laser pointer” to point-out for others particular information projected onto the display screen. The laser pointer generates a narrow beam of visible light that shines on the display as a spot that the user, operator, or presenter, and any other viewers, can see. In one instance, a conventional infrared electronic projector remote control includes an integral laser pointer for pointing to a projected display image. Such an infrared remote control with integral laser pointer is available from In Focus Corporation as a LaserPro™ remote control.

A disadvantage of conventional wireless and infrared remote controls for electronic projectors is that the controllers are typically limited to predefined electronic projector operations. In some instances, an infrared or wireless remote control can also provide computer “mouse” control that is transmitted as infrared or radio frequency signals to a receiver. Corresponding graphical input controls signals are generated from the received infrared or radio frequency signals, and graphical user control of a cursor is projected onto the display screen. A disadvantage is that such sophisticated remote controls are relatively expensive.

Accordingly, the present invention provides a remote electronic projection display control system and method that are associated with an electronic projector for projecting an image onto a display screen. The electronic projector may be positioned behind the display screen as a rear projection display, or in front of the display screen as a front projection display. With regard to the system, a narrow-beam visible light pointer, such as a laser pointer, is operable by a user to direct narrow-beam visible light to the display screen. A multi-pixel light sensor or camera is positioned to receive the narrow-beam visible light from the display screen.

A controller receives from the multi-pixel light sensor a signal corresponding to the narrow-beam visible light directed to the display screen. The controller correlates the narrow-beam visible light with a display screen location and generates a control signal based upon the display screen location. For example, the user may activate a graphical user interface control rendered on the display screen by pressing a light-controlling button that modulates the narrow-beam visible light. The multi-pixel light sensor would detect the modulation and the corresponding activation of the graphical control.

The present invention allows a simple, untethered handheld narrow-beam visible light pointer, such as a laser pointer, to provide complete graphical user interface control for a computer display such as an electronic projector. Such a controller forms a spot on the display so that the operator or user can see what graphical user interface control is being activated, thereby avoiding the problems of operating an infrared or wireless remote control device that relies on hard-to-read keypad markings for indicating the commands. Moreover, the narrow-beam visible light pointer, such as a laser pointer, can be markedly simpler and less expensive than infrared or radio frequency devices that provide graphical user interface control.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is a diagrammatic illustration of a rear projection display system with a remote electronic projection display control system according to the present invention.

FIG. 2 is a diagrammatic illustration of a front projection display system with a remote electronic projection display control system according to the present invention.

FIG. 3 is a flow diagram of an electronic projection display control method for controlling an electronic projector that projects an image onto a display screen.

### DETAILED DESCRIPTION OF PREFERRED EMBODIMENTS

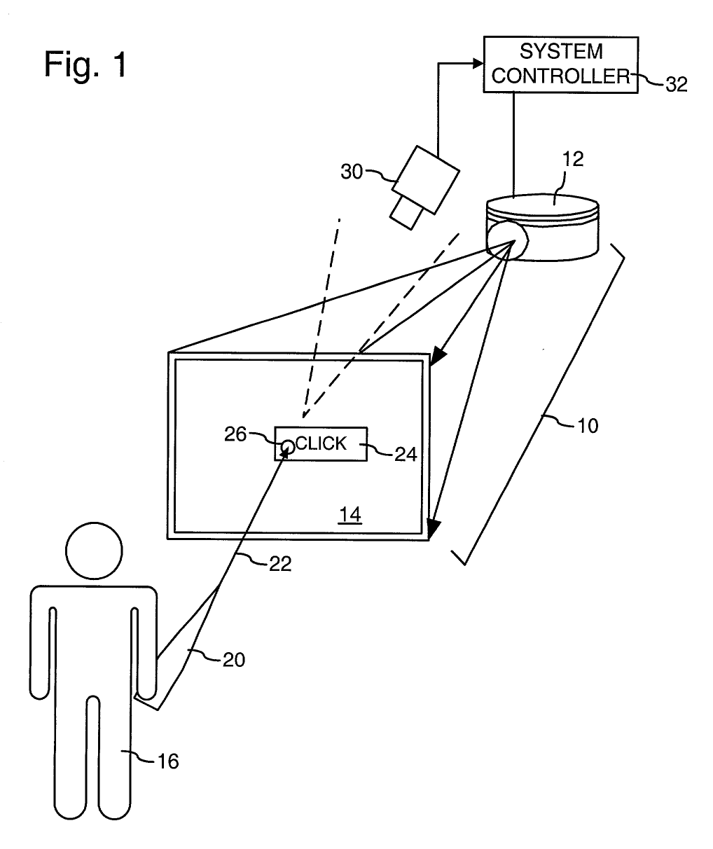

FIG. 1 is a diagrammatic illustration of a rear projection display system 10 having an electronic projector 12 positioned behind a translucent display screen 14. Electronic projector 12 is well-known in the art and may employ any of a variety of electronically-controlled display technologies including liquid crystal displays, digital micromirrors (e.g., DLP™ digital light processing light controllers available from Texas Instruments Incorporated), etc., together with appropriate projection optics.

Electronic projector 12 projects a display image on a rear surface of display screen 14 for viewing by one or more viewers 16 (one shown schematically) who are positioned in front of display screen 14. Commonly, electronic projector 12 would be enclosed by a cabinet (not shown) that also supports display screen 14 about its periphery.

In accordance with the present invention, a hand-held, untethered directed-light pointer 20 is used by viewer 16 to direct a narrow beam 22 of visible light to the front surface of display screen 14. (Directed-light pointer 20 is shown significantly enlarged for purposes of illustration.) For example, the narrow beam 22 of visible light may be directed to selected control areas (e.g., graphical control button 24) that are rendered on display screen 14 by electronic projector 12. Control areas such as graphical control button 24 are analogous to graphical user interface controls common in computer applications. Directed light pointer 20 may include or be implemented as a laser pointer.

A portion of the narrow beam 22 of visible light is reflected from display screen 14 back toward viewer 16 and therefore forms a visible spot 26 where the beam 22 strikes display screen 14. This allows viewer 16 to see where narrow beam 22 is directed and strikes display screen 14. Another portion of the narrow beam 22 passes through translucent display screen 14 and forms a spot on the rear of display screen 14. A multi-pixel light sensor or camera 30 is positioned behind display screen 14, as is electronic projector 12. Light sensor 30 receives light from the rear surface of display screen 14, including the portion of the narrow beam 22 that passes through translucent display screen 14.

Light sensor 30 preferentially detects the light from the directed light pointer 20 passing through translucent display screen 14. The multiple pixels of light sensor 24 correspond to different positions or locations on display screen 14. The location on display screen 14 of spot 26 is therefore detected by light sensor 30 and is provided to a system controller 32. For example, light sensor 30 may operate as a frame capture camera that provides image information to system controller 32. System controller 32 discerns spot 26 from the image information and correlates the location of spot 26 with the projected display image. Directed-light pointer 20, light sensor 30, and system controller 32 together operate as a remote electronic projection display control system.

Directed-light pointer 20 includes one or more viewer-operable keys or buttons (not shown) that the viewer may operate to activate, select, or “click” a control area such as graphical control button 24. The one or more viewer-operable buttons (e.g., typically at least two) would correspond to, and provide the same functionality as, the buttons on a conventional user input device like a computer mouse. In one implementation, user-operation of each button could cause narrow beam 22 to be modulated at a frequency unique to the operated button. The modulation could be at a frequency higher than that perceptible by the viewer.

An advantage of directed-light pointer 20 is that it is remote from and not tethered to projection display system 10. This gives the viewer optimal freedom of movement relative to projection display system 10, even at relatively large distances of 10 meters or more.

Light sensor 30 may be adapted to preferentially detect the light from the directed light pointer 20 by placement of a narrow-band color filter between light sensor 30 and the rear surface of display screen 14. The narrow-band color filter would be adapted to pass a narrow color band of light corresponding to the light transmitted from directed-light pointer 20. Alternatively, the light from the directed light pointer 20 may be preferentially detected by application of an electronic color filter that preferentially passes to controller system 32, or identifies within controller 32, image information of the color corresponding to the light from the directed-light pointer 20.

As another alternative implementation, two or more directed-light pointers 20 may be used simultaneously with projection display system 10, such as by different viewers. Each of the plural directed-light pointers 20 could transmit a narrow beam 22 of a different color so that the corresponding visible spots 26 can be distinguished by viewers and by one or more light sensors 30. In one implementation, a different light sensor 30 could be configured with a narrow-band color filter to receive the light from just one of the directed-light pointers 30.

In one exemplary implementation, light sensor 30 may have an array of at least 320×240 pixels so that it is of small size and low cost. In use with a display screen 14 with dimensions of 12.5 inches-by-34 inches (about 32 cm-by-86 cm), for example, such a light sensor 30 can provide reasonably precise location information. With the 32 inch width, the 320 horizontal TV pixels would yield 0.1″ horizontal screen position sensing. Vertically, the precision would be about 0.05 inches.

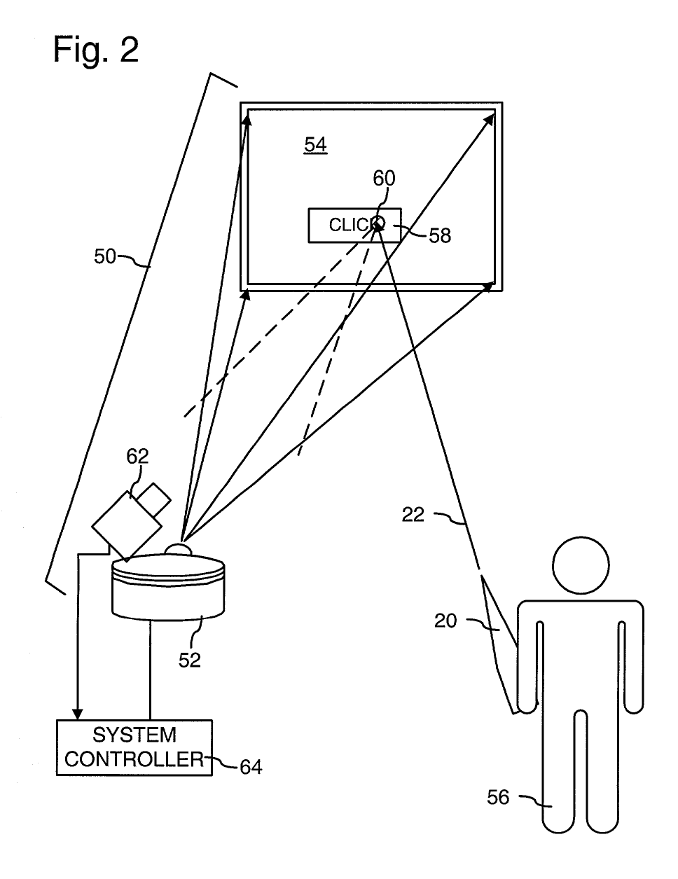

FIG. 2 is a diagrammatic illustration of a front projection display system 50 having an electronic projector 52 positioned in front of a reflective display screen 54 with a viewer 56. Electronic projector 52 is well-known in the art and may employ any of a variety of electronically-controlled display technologies including liquid crystal displays, digital micromirrors (e.g., DLP™ digital light processing light controllers available from Texas Instruments Incorporated), etc., together with appropriate projection optics. Electronic projector 52 projects a display image on a front surface of display screen 54 for viewing by one or more viewers 56 (one shown schematically) who are also positioned in front of display screen 54.

Directed-light pointer 20 is used by viewer 56 to direct a narrow beam 22 of visible light to the front surface of display screen 54. For example, the narrow beam 22 of visible light may be directed to selected control areas (e.g., graphical control button 58) that are rendered on display screen 54 by electronic projector 52. Control areas such as graphical control button 58 are analogous to graphical user interface controls common in computer applications.

The narrow beam 22 of visible light is reflected from display screen 54 back toward viewer 56 and therefore forms a visible spot 60 where the beam 22 strikes display screen 54. This allows viewer 56 to see where narrow beam 22 is directed and strikes display screen 54. A multi-pixel light sensor or camera 62 is positioned to receive light reflected from display screen 54. For example, light sensor 62 may be positioned or integrated with electronic projector 52. Light sensor 62 receives light from the front surface of display screen 54, including the portion of the narrow beam 22 that is reflected by display screen 54.

Light sensor 62 preferentially detects the light from the directed light pointer 20 and reflected by display screen 54. The multiple pixels of light sensor 62 correspond to different positions or locations on display screen 54. The location on display screen 54 of spot 60 is therefore detected by light sensor 62 and is provided to a system controller 64. For example, light sensor 62 may operate as a frame capture camera that provides image information to system controller 64. System controller 64 discerns spot 60 from the image information and correlates the location of spot 60 with the projected display image. In other regards, the operation of system controller 64 is the same as that of system controller 32.

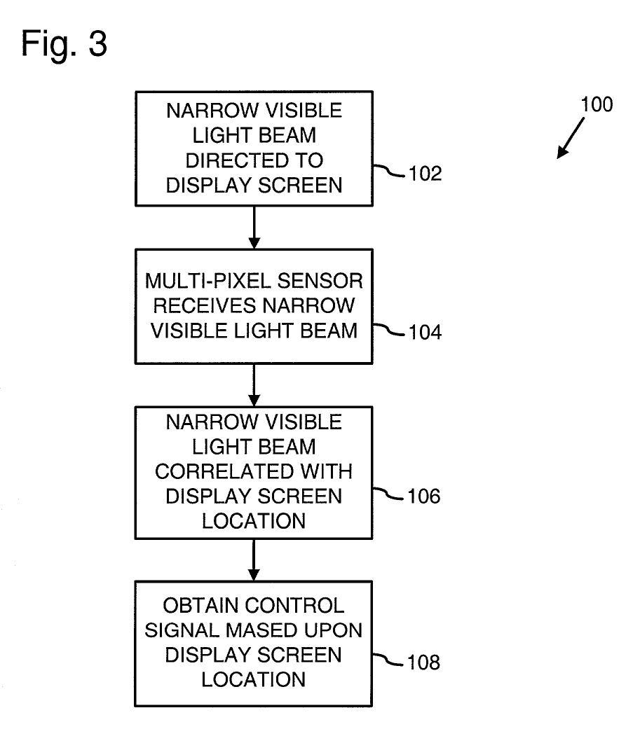

FIG. 3 is a flow diagram of an electronic projection display control method 100 for controlling an electronic projector that projects an image onto a display screen.

Process block 102 indicates that a narrow visible light beam is manually directed to a display screen of an electronic projection display by a user or viewer. For example, the user or viewer may manually operate a hand-held, untethered, remote narrow-beam visible light source (e.g., a laser pointer).

Process block 104 indicates that a multi-pixel light sensor receives the narrow-beam visible light from the display screen.

Process block 106 indicates that the narrow-beam visible light from the display screen is correlated with a display screen location.

Process block 108 indicates that a control signal based upon the display screen location is obtained. For example, the control signal may be obtained in response to a variation or change in the light beam (e.g., a modulation) while it strikes a graphical control element or another display element. The variation or change can occur in response to user activation of a light beam control button on the hand-held, untethered, remote narrow-beam visible light source.

Having described and illustrated the principles of our invention with reference to an illustrated embodiment, it will be recognized that the illustrated embodiment can be modified in arrangement and detail without departing from such principles. In view of the many possible embodiments to which the principles of our invention may be applied, it should be recognized that the detailed embodiments are illustrative only and should not be taken as limiting the scope of our invention. Rather, I claim as my invention all such embodiments as may come within the scope and spirit of the following claims and equivalents thereto.

1. A remote electronic projection display control system associated with an electronic projector for projecting an image onto a display screen, comprising:
a narrow-beam visible light pointer operable by a user to direct narrow-beam visible light to the display screen;
a multi-pixel light sensor positioned to receive from the display screen the narrow-beam visible light directed to the display screen; and
a controller receiving from the multi-pixel light sensor a signal corresponding to the narrow-beam visible light directed to the display screen, the controller correlating the narrow-beam visible light with a display screen location and generating a control signal based upon the display screen location.

2. The system of claim 1 in which the light pointer includes a laser and the narrow-beam visible light is laser light.

3. The system of claim 1 in which the light sensor includes an array of pixels with dimensions of at least 320 pixels-by-240 pixels.

4. The system of claim 1 in which the display screen is translucent and the electronic projector and the light sensor are positioned behind the display screen on a side opposite the user.

5. The system of claim 1 in which the display screen is reflective and the electronic projector and the light sensor are positioned in front of the display screen on a side with the user.

6. The system of claim 1 in which the narrow-beam visible light from the light pointer is preferentially detected relative to other light visible from the electronic projector display screen.

7. The system of claim 6 further comprising a light filter through which light passes to the light sensor, the light filter preferentially passing light from the light pointer.

8. A remote electronic projection display control method for controlling an electronic projector that projects an image onto a display screen, comprising:
receiving at a multi-pixel light sensor a portion of a narrow-beam light visible from the electronic projector display screen and manually directed thereto by a viewer;
correlating the narrow-beam light visible from the display screen with a display screen location; and
obtaining a control signal based upon the display screen location.

9. The method of claim 8 in which the narrow-beam light is a laser light emitted by an untethered remote laser light pointer.

10. The method of claim 8 in which the control signal is obtained in response to a modulation of the narrow-beam light beam.

11. The method of claim 10 in which the control signal is obtained while the narrow-beam light beam strikes a graphical control element rendered at the display screen location.

12. The method of claim 8 in which the narrow-beam light is received at the multi-pixel light sensor after passing through the electronic projector display screen.

13. The method of claim 8 in which the narrow-beam light is received at the multi-pixel light sensor after being reflected from the electronic projector display screen.

14. The method of claim 8 in which the narrow-beam light visible from the electronic projector display screen is preferentially received at the multi-pixel light sensor relative to other light visible from the electronic projector display screen.

15. The method of claim 8 in which the narrow-beam light visible from the electronic projector display screen and received at the multi-pixel light sensor is preferentially detected relative to other light visible from the electronic projector display screen.

16. An electronic projector display system, comprising:
an electronic display projector;
a display screen that receives a display image from the electronic display projector;
a hand-held, untethered narrow-beam visible light pointer operable by a user to direct narrow-beam visible light to the display screen;
a multi-pixel light sensor positioned to receive from the display screen the narrow-beam visible light directed to the display screen; and
a controller receiving from the multi-pixel light sensor a signal corresponding to the narrow-beam visible light directed to the display screen, the controller correlating the narrow-beam visible light with a display screen location and generating a control signal based upon the display screen location.

17. The system of claim 16 in which the light pointer includes a laser and the narrow-beam visible light is laser light.

18. The system of claim 16 in which the light sensor includes an array of pixels with dimensions of at least 320 pixels-by-240 pixels.

19. The system of claim 16 in which the display screen is translucent and the electronic projector and the light sensor are positioned behind the display screen on a side opposite the user.

20. The system of claim 16 in which the display screen is reflective and the electronic projector and the light sensor are positioned in front of the display screen on a side with the user.

21. The system of claim 16 in which the narrow-beam visible light from the light pointer is preferentially detected relative to other light visible from the electronic projector display screen.

22. The system of claim 21 further comprising a light filter through which light passes to the light sensor, the light filter preferentially passing light from the light pointer.

23. A display control system associated with a display system that forms an image on a display screen, comprising:
a narrow-beam visible laser light pointer operable by a user to direct narrow-beam visible laser light to the display screen;
a multi-pixel light sensor positioned to receive from the display screen the narrow-beam visible laser light directed to the display screen; and
a controller receiving from the multi-pixel light sensor a signal corresponding to the narrow-beam visible laser light directed to the display screen, the controller correlating the narrow-beam visible light with a display screen location and generating a control signal based upon the display screen location.
